(19) United States
(12) Patent Application Publication
(10) Pub. No.: US 2010/0274423 A1
(43) Pub. Date: Oct. 28, 2010

(54) Idle speed regulation for a hybrid vehicle

(76) Inventors: Andreas Seel, Bonn (DE); Thorsten Juenemann, Sindelfingen (DE)

Correspondence Address: KENYON & KENYON LLP, ONE BROADWAY, NEW YORK, NY, 10004, US

(21) Appl. No.: 12/680,851

(22) PCT Filed: Sep. 23, 2008
(86) PCT No.: PCT/EP08/62679

§ 371 Date: Mar. 30, 2010

(30) Foreign Application Priority Data
Oct. 5, 2007 (DE) 102007047712.2

(51) Int. Cl. B60W 20/00

(52) U.S. Cl. 701/22; 180/65.28; 903/902

(57) ABSTRACT

A regulating method for hybrid vehicles having an electric motor and an internal combustion engine, for rotational speed regulation of the electric motor, including detecting the driving speed of the vehicle, detecting a desired torque, and comparing the driving speed with a driving speed minimum value, in which, when a desired torque below a torque minimum value is detected and the comparison yields the result that the driving speed is not above the driving speed minimum value, the electric motor is regulated to a setpoint idle speed which is below the minimum idle speed of the internal combustion engine.

### FIELD OF THE INVENTION

The present invention is directed to a regulation method for hybrid vehicles whose power plant includes an electric motor as well as an internal combustion engine. Depending on the power request and the driving situation, the internal combustion engine is started whose rotational energy is transferred to the electric motor and/or is used to drive the vehicle. In general, transmissions and clutches are used for the suitable mechanical linkage between the electric motor and the internal combustion engine.

### BACKGROUND INFORMATION

European Patent Application EP 1 571 315 A2 discusses an idle speed regulation of a power plant having an internal combustion engine which is driven by a starter during the starting process. Two rotational speeds are provided which are activated consecutively.

Internal combustion engines typically have an idle speed, which has a minimum of approximately 600 rpm, since lower rotational speeds may result in instabilities; for example, the internal combustion engine stalls, in particular during starting situations or when engaging the internal combustion engine. Such a minimum idle speed is adhered to in all internal combustion engines irrespective of whether or not they are used in hybrid vehicles. According to the related art, electric motors in hybrid vehicles are also provided with a minimum idle speed which corresponds to the idle speed of the internal combustion engine. This is used in particular to provide the vehicle also in electric operation with a driving characteristic which corresponds to the driving characteristic of vehicles driven by internal combustion engines. As in internal combustion engines, this results in a creep speed when the electric drive is engaged as it is already known from vehicles operated by an internal combustion engine when driven in engaged first gear.

In particular such creep speeds, where the electric motor is used as the drive, result in poor efficiency and increased wear of clutch elements or other elements which are used for transferring the rotation between the power plant and the output. If the vehicle drive is disengaged, it results in substantial power consumption due to the high idle speed of the motor which does not contribute to the movement of the vehicle. Poor efficiency results in particular when hydraulic torque converters are used, essentially since the torque converter represents a mechanical load.

### SUMMARY OF THE INVENTION

According to the exemplary embodiments and/or exemplary methods of the present invention, the idle speed of the electric motor is provided to be lower than the idle speed of the internal combustion engine in order to be able to utilize the advantages of the electric motor compared to the internal combustion engine during idling. At the same time, the driving characteristic is not affected since lowering the idle speed of the electric motor below the idle speed of the internal combustion engine is associated with a query which may be used to find out whether the idle speed can actually have an effect on the driving characteristic. The query includes the evaluation and query of the driving speed of the vehicle and/or the evaluation and query of a desired torque. In this way, in a simple comparison of the driving speed with a minimum driving speed value it is established whether the driving speed corresponds to a creep speed, to a very slow speed, or to a standstill wherefrom a conclusion is drawn whether, due to the slow speed, a change in the rotational speed actually results in a noticeable change in the driving characteristic. By detecting a desired torque it is checked whether the driver is requesting a certain rotational speed or a certain torque for acceleration or whether a reduction of the rotational speed for improving the efficiency level is compatible with the desired torque. For this purpose, a desired torque, which is input by the driver via an accelerator pedal and/or a brake pedal, is compared with a minimum torque value whereby it is ascertained whether the torque desired by the driver is negligible or zero. In particular, by pressing the brake pedal it is concluded that a reduction in the rotational speed of the electric motor is compatible with the desired driving characteristic.

The rotational speed of the drive shaft of the electric motor is referred to as the rotational speed of the electric motor. It may be identical to the rotor speed of the electric motor or, due to a speed increase or a speed reduction, it may be a multiple or a fraction thereof.

According to the exemplary embodiments and/or exemplary methods of the present invention, both queries are linked via an OR logic, so that the setpoint idle speed is reduced below the idle speed of the internal combustion engine when the driving speed or the desired torque is low to such an extent that the change in the driving characteristic is negligible due to the reduction of the setpoint idle speed or cannot be detected by the driver. According to another embodiment, the results of the two queries are combined via an AND operation. It may be ascertained whether the driving speed is zero, it corresponding to a driving speed threshold value of 0 km/h. It is ascertained at the same time whether a non-negligible desired torque is present. For this purpose, it is detected whether the driver is braking or has engaged an idle gear, from which it may be concluded that the requested torque or the desired torque is zero or negligible. If it is ascertained due to the detection of driving speed and desired torque that the driving characteristic cannot be affected by a reduction in the setpoint idle speed, then the electric motor is regulated to a setpoint idle speed which is below the minimum idle speed of the internal combustion engine.

Such a regulation corresponds to the normal regulation mechanisms in which a setpoint value is predefined, an actual value is measured and the error, i.e., the difference between the actual value and the setpoint value, is ascertained. Due to the suitable feedback of the error for influencing a manipulated variable it is achieved that the actual value approaches the setpoint value until the actual value as the manipulated variable is equal to the setpoint value.

Normal regulation mechanisms, which may also be used for implementing the exemplary embodiments and/or exemplary methods of the present invention, include a negative feedback of the error as well as a gain element P, a delay-differential element D, and/or an integral element I. The controllers used may thus be P, PI, PD, or PID controllers. The actual variable and the setpoint variable of the regulation are provided in the exemplary embodiments and/or exemplary methods of the present invention as the actual rotational speed of the electric motor and the setpoint idle speed or the setpoint rotational speed of the electric motor; the manipulated variable of the regulation mechanism is implemented in the exemplary embodiments and/or exemplary methods of the present invention as the excitation signal of the electric motor, e.g., as the speed or the intensity of a rotating E field or as the excitation current of one or multiple excitation windings of the electric motor. As the manipulated variable or variables, the speed and/or the intensity of the rotating field is/are used in asynchronous machines, the intensity or the speed of the electrical rotating field in synchronous machines, and the current flowing through the excitation winding and the current flowing through the armature winding in d.c. machines. The speed in this connection with respect to electric machines includes: angular speed, speed of rotation, predefined rotational speed, or predefined rotating field frequency.

The driving speed of the vehicle and the desired torque do not necessarily have to be exactly zero in order to trigger a reduction in the setpoint idle speed. Instead, the desired torque as well as the driving speed may be slightly above zero or have a value which is negligible with regard to the change in the driving characteristic. Therefore, the driving speed threshold value may be below 0.1 km/h, below 5 km/h, or below another speed value in which the change in the driving characteristic by reducing the idle speed is negligible. In the same way, the brake pedal position, the idle position of the transmission, or the accelerator pedal position may be detected. According to the exemplary embodiments and/or exemplary methods of the present invention, if the accelerator pedal is only minimally pressed it may be assumed that a reduction in the setpoint idle speed has only a negligible effect on the driving characteristic or an effect tolerable by the driver.

Accordingly, the setpoint idle speed may only be slightly reduced below the minimum idle speed of the internal combustion engine, e.g., from 600 rpm to 500 rpm, if a greater reduction in the rotational speed would result in an essentially undesirable change in the driving characteristic.

The magnitude of the reduction or the level of the difference between the setpoint idle speed and the minimum idle speed of the internal combustion engine may thus be provided as a function of the driving speed and as a function of the desired torque, the difference being the smaller the higher the desired torque is or the higher the driving speed is. A linearly weighted sum may be used for this or another function which combines the desired torque and the driving speed in a suitable weighted manner and computes therefrom the setpoint idle speed and the magnitude of the reduction in the rotational speed with respect to the idle speed of the internal combustion engine. The desired torque and the driving speed may thus be combined to an extent which represents the sensitivity to rotational speed reductions and the effect on the driving characteristic detectable by the driver. If the sensitivity is low, e.g., at a standstill or a disengaged gear, the rotational speed may be greatly reduced, e.g., to zero, whereas if the sensitivity is high, e.g., at a driving speed of more than 2 km/h, the idle speed is reduced only slightly below the value which is typical for internal combustion engines, e.g., to 400 to 500 rpm.

A mechanical load may be provided as another influencing variable which decelerates the rotational motion of the electric motor, e.g., a hydraulic torque converter. The torque, which passes over from the electric motor to the mechanical load due to the deceleration, may be used as an additional influencing manipulated variable. For example, the setpoint idle speed is thus selected in such a way that the torque output to the mechanical load does not exceed a certain torque output threshold value, the torque output being a direct function of the rotational speed of the electric motor. Such a regulation limits the setpoint idle speed on the upside, the limit being defined by the torque output threshold value. The difference between the actual torque output and the torque output threshold value or the level of the torque output itself may be detected and may be used as another weighted factor in the above-described computation of the setpoint idle speed. It may be taken into account that the torque output carries more weight the closer the setpoint idle speed is to the minimum idle speed, thereby influencing the computation of the setpoint idle speed in an inverse way compared to the desired torque and the driving speed.

Hydraulic torque converters are used for coupling the electric motor to the driving wheels of the vehicle, the torque converter absorbing sudden acceleration changes. In a hydraulic torque converter, the output side and the drive side of the torque converter are connected via a hydraulic fluid, so that, in the event of a rotational speed difference, the hydraulic fluid, e.g., oil, connects them via a turbine. The greater the rotational speed difference, the greater is the torque transfer from the output side to the drive side of the torque converter. If the output side runs synchronously with the wheels of the vehicle and the drive side runs synchronously with the electric motor, then the torque converter represents a mechanical load when the rotational speed of the output side is lower than the rotational speed of the drive side by a rotational speed difference. According to one embodiment of the present invention, the electric motor is regulated in such a way that the rotational speed difference is zero, the rotational speed difference may be unequal to zero, e.g., constant, and the idle speed thus being corrected to be slightly below the rotational speed of the drive side, i.e., the turbine rotational speed. According to a further embodiment, if a torque converter is used, the rotational speed of the electric motor and thus also the rotational speed difference are regulated in such a way that the torque output, i.e., the torque which is transferred from the electric motor to the torque converter has a predetermined value, e.g., a constant value greater than zero. The torque output like the rotational speed difference may also have a value equal to zero, e.g., when the clutch is disengaged. However, the torque output may be kept to a low, predetermined value by correspondingly regulating the rotational speed of the electric motor with respect to the rotational speed of the output side of the torque converter.

According to a further embodiment of the present invention, the electric motor is operated as a generator during regulation of the actual rotational speed of the electric motor or of the setpoint idle speed in order to allow recuperation. During recuperation, the kinetic energy of the vehicle is converted due to deceleration into electrically storable energy via an electric motor, operated as a generator, and stored in an electric accumulator. To provide a preferably high efficiency level during recuperation, the electric motor, provided for the drive, is operated as a generator according to the present invention and the actual rotational speed of the electric motor (which results from the vehicle speed and the transmission ratio between the wheel and the electric motor) is used for power generation as efficiently as possible. The method according to the present invention may include detection of the actual rotational speed of the electric motor.

The setpoint idle speed of the electric motor corresponds in this case to the target of the regulation, i.e., the controlled variable, the actual rotational speed reflecting the rotational speed of the rotor and the setpoint idle speed reflecting the rotating field, for example. Those skilled in the art know from the mode of operation of electric machines that phase and speed differences between the rotor and the stator result in an induced voltage which may be discharged as generated electric power. In order to achieve high generator performance, the difference between the actual rotational speed and the setpoint idle speed is provided as great as possible, the set setpoint idle speed may differ greatly from the actual rotational speed of the electric motor at low actual rotational speeds, and a smaller difference being provided at higher actual rotational speeds. In particular, at low rotational speeds, a high generator performance is still generated, thereby increasing the efficiency level. Moreover, the difference between the setpoint idle speed and the actual rotational speed directly affects the deceleration of the vehicle so that the difference is limited or is appropriately regulated to limit the speed decrease. Furthermore, the difference may depend on the charge state of the electric accumulator so that at a high charge state of the electric accumulator only a small difference is provided to reduce the generator performance and at a low charge state of the electric accumulator the difference is provided in such a way that high generator performance is obtained to quickly recharge the electric accumulator. The efficiency level of recuperation may be increased in that a possibly present torque converter or a clutch, connecting it to the electric machine, is opened, so that the torque output to the torque converter is negligible and almost the entire rotational energy of the electric motor, operated as a generator, is converted into electric energy to be stored.

According to a further embodiment of the present invention, additional mechanical loads, which decelerate the electric motor, are considered, e.g., a transmission which requires a minimum input rotational speed for maintaining the oil pressure. Further mechanical loads, which require a minimum rotational speed, are, for example, the air conditioning system, the dynamo, or other devices which require a minimum rotational speed or minimum rotational energy. Therefore, the regulation method may be provided at a minimum setpoint rotational speed, e.g., at least 50 rpm, at least 100 rpm, at least 150 rpm, or at least 200 rpm, under which the actual rotational speed will not drop. The actual rotational speed also preferably does not drop below the minimum rotational speed even when other above-described regulation components would require a reduction of the setpoint idle speed.

According to another embodiment of the present invention, a degree of tolerance is input by the driver which reflects the preparedness to tolerate a change in the driving characteristic in favor of improved efficiency. Such an input may influence at least one of the above-described threshold values or minimum values, e.g., the driving speed threshold value, below which the regulation method according to the present invention may provide the setpoint idle speed below the minimum idle speed of the internal combustion engine. Furthermore, such an input may influence the operation threshold value which refers to the operation of the vehicle's accelerator pedal whereby, if high tolerance preparedness is indicated, the operation of the accelerator pedal does not influence the idle speed or the setpoint idle speed completely but only partly. Instead of or in combination with an input of a tolerance degree, which refers to the change in the driving characteristic by the regulation method, operating parameters such as a still available range, the charge state of the battery, the filling level of the fuel tank, etc., may be used to determine the intensity of the influence of the regulating method on the rotational speed.

For example, if only a small amount of fuel remains in the tank, the battery has a low charge state, or a preferably high efficiency level is to be obtained for other reasons, then the regulation method may be adjusted by modification of the minimum values or the threshold values in such a way that the efficiency level is increased at the expense of a great change in the driving characteristic. If the driver's input requires that the regulation method according to the present invention intervenes in the idle speed regulation more intensely, then the efficiency level is increased but at the same time the driving characteristic is greatly changed. The intensity of the intervention by the regulation method in the regulation of the torque depends on the above-described minimum values and threshold values which in turn depend on the driver's inputs.

The regulation method may be implemented with the aid of software, hardware, or a combination thereof. The regulation method may be implemented at least partly using software which runs on a controller, the controller being connected to an interface or includes an interface via which the control signals and the settings of the setpoint idle speed are output. Such an interface may also include inputs and detect the rotational speeds, torque inputs, i.e., inputs of the desired torque, the driving speed, or additional above-described operating parameters of the hybrid vehicle. The guidance or correction of the actual rotational speed to the setpoint idle speed, which is predefined by the regulation method according to the present invention, may be carried out by a normal setpoint/actual value controller which is also implemented as software, hardware or a combination thereof in the form of a microcontroller having a memory, which in combination implement the regulation method according to the present invention.

Sensors already present in the vehicle may be used for detecting the above-described operating parameters of the vehicle, or a data interface may be provided which is associated with a data processing unit to which at least one of the sensors is connected.

The regulation method is suitable for serial hybrid drives and in particular for parallel hybrid drives.

Exemplary embodiments of the present invention are explained in greater detail in the following description based on the drawing.

### BRIEF DESCRIPTION OF THE DRAWING

FIG. 1 shows rotational speed curves which result from the method according to the present invention and a rotational speed curve from the related art which is used for comparison.

### DETAILED DESCRIPTION

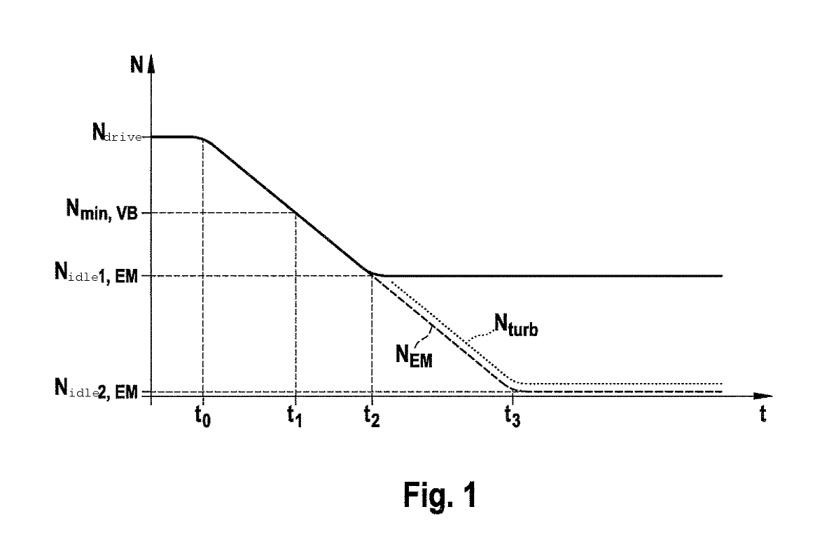

FIG. 1 shows a rotational speed curve which results when the regulation method according to the present invention is carried out. The rotational speed is plotted on the y axis and is labeled with N, whereas the time is plotted along the x axis and labeled with t. The solid line in the diagram represents the actual rotational speed of an electric motor as it appears when the regulation method according to the present invention is carried out. Until point in time t₀, the vehicle is driven at a constantly high driving speed which is linked to a constantly high rotational speed N_{drive}. From point in time t₀, the driving speed and thus also the actual rotational speed of the electric motor are reduced according to the driver's input. Due to the driver's input, the actual rotational speed of the electric motor decreases continuously and reaches at point in time t₁ the minimum idle speed N_{min, VB} which corresponds to the minimum rotational speed of the internal combustion engine. As already mentioned, internal combustion engines always have minimum rotational speeds, below which unstable operating states occur. According to the related art, this minimum idle speed N_{min, VB} would also be maintained for the electric motor from point in time t₁. However, the regulating method according to the present invention provides a further reduction from point in time t₁ since, according to the present invention, the minimum idle speeds of an internal combustion engine do not have to be taken into account due to the operation of the electric motor. At point in time t₂, the actual rotational speed reaches a setpoint idle speed N_{idle1, EM} which is predefined from point in time t₁ and which is reached at point in time t₂ due to the inertia of the electric motor and the regulation. The difference between minimum idle speed N_{min, VB} and setpoint idle speed N_{idle1, EM} corresponds directly to the efficiency improvement which may be achieved using the method according to the present invention.

While a first, predetermined and constant setpoint idle speed N_{idle1, EM} has a relatively high value, a very low setpoint idle speed N_{idle2, EM} is provided according to a further embodiment of the present invention, which is also activated from point in time t₁ and is pursued by the regulation mechanism, and is reached at point in time t₃. As is apparent in FIG. 1, setpoint idle speed N_{idle2, EM} has a value which differs only slightly from zero in order to provide a minimum rotational speed for certain consumers, for example. The corresponding curve of the actual rotational speed is represented as a dashed line labeled N_{EM}.

In a further embodiment of the present invention, a very low setpoint idle speed is also provided which, however, is slightly above setpoint idle speed N_{idle2, EM}. The curve of the actual rotational speed is represented in FIG. 1 as a dotted curve labeled N_{turb}. Since, according to an exemplary embodiment of the present invention, in which the electric motor is connected to the output via a torque converter, a low torque is transferred to the torque converter, a small rotational speed difference exists from point in time t₃, N_{EM} representing the rotational speed of the output side and rotational speed N_{turb} is the rotational speed of the drive side. The output side indicates the connection of the torque converter which is connected to the wheel and the drive side indicates the connection of the torque converter which is connected to the electric motor. The torque converter is thereby held under a certain pre-stress, which, at the same time, however, is low enough that the efficiency of the electric motor is not substantially impaired. The rotational speed of the output side N_{EM}, which is essentially zero from point in time t₃, corresponds to a driving speed of essentially zero and the small distance between rotational speed N_{turb} and the time axis from point in time t₃ corresponds to a residual rotational speed with which the electric motor rotates and with which the electric motor runs against the torque converter. If from point in time t₂ the clutch between the electric motor and the wheel is open, then there is no torque output to the torque converter.

In FIG. 1, a desired torque below a torque minimum value may generally be detected at point in time t₀, for example by disengaging the electric motor or by operating the brake.

1-10. (canceled)

11. A regulating method for a hybrid vehicle, which has an electric motor and an internal combustion engine, for providing rotational speed regulation of the electric motor, the method comprising:
detecting a driving speed of the vehicle;
detecting a desired torque; and
comparing the driving speed with a driving speed minimum value;
wherein, when a desired torque below a torque minimum value is detected and the comparison yields the result that the driving speed is not above the driving speed minimum value, the electric motor is regulated to a setpoint idle speed which is below the minimum idle speed of the internal combustion engine.

12. The regulation method of claim 11, wherein the detecting of the desired torque below a minimum value includes at least one of:
detecting an operation of a brake pedal;
detecting an idle gear of a transmission which controllably connects the electric motor to the output of the vehicle; and
detecting an operating state of an accelerator pedal of the vehicle which corresponds to a non-operation or which corresponds to a degree of operation below an operation threshold value.

13. The regulation method of claim 11, wherein one of the following is satisfied: (i) the driving speed threshold value is below 0.1 km/h, below 0.2 km/h, below 0.5 km/h, below 1 km/h, below 2 km/h or below 5 km/h, and (ii) the driving speed threshold value is essentially 0 km/h and is detected by recognizing a wheel standstill.

14. The regulation method of claim 11, wherein the setpoint idle speed of the electric motor is lower than or equal to 500×1/min, lower than or equal to 400×1/min, lower than or equal to 200×1/min, lower than or equal to 100×1/min, or lower than or equal to 50×1/min, or is approximately 0×1/min.

15. The regulation method of claim 11, wherein the setpoint idle speed of the electric motor, which represents a manipulated variable of the regulation, is regulated so that a torque output, which represents a controlled variable of the regulation, to a mechanical load, which is connected to the electric motor, does not exceed a torque output threshold value.

16. The regulation method of claim 15, wherein the mechanical load includes a torque converter having an output side and a drive side to which the electric motor is connected, when the rotational speed of the output side is lower than the rotational speed of the drive side by a rotational speed difference, the rotational speed is at least one of (i) regulated to hold the rotational speed difference at a predetermined value, and (ii) regulated to hold the torque output at a predetermined value.

17. The regulation method of claim 11, further comprising:
detecting the actual rotational speed of the electric motor, wherein the electric motor is operated as a generator, and the regulating of the electric motor to a setpoint idle speed includes exciting the electric motor according to the setpoint idle speed;
wherein at least one of the following is satisfied: (i) the difference between the set setpoint idle speed and the actual rotational speed of the electric motor increases with decreasing actual rotational speed, and (ii) at a low charge state of an electric energy accumulator which is charged by the electric motor operated as a generator, the difference between the set setpoint idle speed and the actual rotational speed of the electric motor is greater than the difference between the set setpoint idle speed and the actual rotational speed of the electric motor at a charge state which is higher than the low charge state.

18. A rotational speed controller for regulating the rotational speed of an electric motor which is used as a power plant of a hybrid vehicle, comprising:
an speed data input arrangement for receiving driving speed data of the vehicle;
a torque data input arrangement for receiving desired torque data; and
a comparator to compare the driving speed data with a driving speed minimum value;
an output arrangement;
a control device, which is connected to the output arrangement, to output a manipulated variable signal which is used to regulate the setpoint idle speed of the electric motor according to a regulating process for the hybrid vehicle, which has the electric motor and an internal combustion engine, for providing rotational speed regulation of the electric motor, by performing the following:
detecting a driving speed of the vehicle,
detecting a desired torque, and
comparing the driving speed with a driving speed minimum value, wherein, when a desired torque below a torque minimum value is detected and the comparison yields the result that the driving speed is not above the driving speed minimum value, the electric motor is regulated to a setpoint idle speed which is below the minimum idle speed of the internal combustion engine.

19. The rotational speed controller of claim 18, further comprising:
at least one of the following:
(i) a torque output data input arrangement for receiving torque output data of the electric motor, wherein the comparator is compares the torque output data with a torque output threshold value; and
(ii) a rotational speed difference arrangement to detect the rotational speed difference between an output side and a drive side of a torque converter;
Wherein the control device is configured to regulate one of the rotational speed difference and the torque output to a predetermined value.

20. The rotational speed controller of claim 18 which also includes an input which is designed to detect data about the actual rotational speed of the electric motor and/or which also includes an input which is designed to detect charge state data of an electric energy accumulator which is connected to the electric motor.
